(19) United States
(12) Patent Application Publication
(10) Pub. No.: US 2007/0170153 A1
(43) Pub. Date: Jul. 26, 2007

(54) Resistance welding electrode, method of manufacturing the same, resistance welding apparatus, and resistance welding line

(76) Inventors: Akihiro Goto, Tokyo (JP); Tadanao Sugiura, Nagoya (JP); Kazushi Nakamura, Tokyo (JP); Masahiro Okane, Tokyo (JP); Hiroyuki Ochiai, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/588,776

(22) PCT Filed: Nov. 29, 2004
(86) PCT No.: PCT/JP04/17698

§ 371 Date: Aug. 8, 2006

(51) Int. Cl. B23K 11/30

(52) U.S. Cl. 219/119

(57) ABSTRACT

A resistance welding electrode includes a first layer of a metal-carbide film that is formed by attaching or carbonizing of an electrode material on a surface of the resistance welding electrode by applying a voltage between a powder molding obtained by molding a powder consisting mainly of a metal powder that is likely to be carbonized or a metal compound powder or a powder molding obtained by heating the powder molding in a working fluid and the resistance welding electrode, to generate a pulse-like discharge in; and a second layer obtained by forming a film consisting mainly of any one of chrome, nickel, iron, tungsten, and molybdenum on the first layer.

### TECHNICAL FIELD

The present invention relates to an electrode for a resistance welding utilizing a discharge surface treatment that forms a film of an electrode material or a material obtained from a reaction of the electrode material by discharge energy on the surface of a workpiece, a resistance welding apparatus using the electrode, and a part manufacturing line using the resistance welding apparatus.

### BACKGROUND ART

Inventions related to electrodes, such as a spot chip, a cap chip, and a disc-like electrode used for resistance welding, such as spot welding and seam welding, are disclosed in Japanese Patent Application Laid-Open No. H10-128554, Japanese Patent Application Laid-Open No. H10-34351, and Japanese Patent Application Laid-Open No. H8-81723.

In general, welding electrodes, and the like are made of a material including copper (Cu) as a main component. However, the service life is short because the electrode is used under severe conditions of heat and spattering of molten materials, and so the electrode must be replaced frequently. Due to the short service life, the replacement interval was normally several days or several hours in shorter ones.

Each of the inventions described in the above Patent Literatures is intended to prolong the service life of the electrode: Japanese Patent Application Laid-Open No. H10-128554 and Japanese Patent Application Laid-Open No. H10-34351 describe inventions intended to prolong the service life by cooling the electrode and Japanese Patent Application Laid-Open No. H8-81723 describes an invention intended to prolong the service life by selecting a proper material of the electrode. However, although all the patent literatures are intended to prolong the service life of the electrode, they are not considered to be particularly effective.

Patent literature 1: Japanese Patent Application Laid-Open No. H10-128554

Patent literature 2: Japanese Patent Application Laid-Open No. H10-34351

Patent literature 3: Japanese Patent Application Laid-Open No. H8-81723

### DISCLOSURE OF THE INVENTION

### PROBLEM TO BE SOLVED BY THE INVENTION

The present invention is intended to largely improve the short service lives of resistance welding electrodes, to provide a welding apparatus that requires less frequent replacement of the electrodes, and to provide a part manufacturing line that requires less frequent stoppages of the line for electrode replacement by introducing the welding apparatus according to the present invention.

### MEANS FOR SOLVING THE PROBLEM

To achieve the above abject, a resistance welding electrode according to one aspect of the present invention includes a first layer of a metal-carbide film that is formed by attaching or carbonizing of an electrode material on a surface of the resistance welding electrode by applying a voltage between a powder molding obtained by molding a powder consisting mainly of a metal powder that is likely to be carbonized or a metal compound powder or a powder molding obtained by heating the powder molding in a working fluid and the resistance welding electrode, to generate a pulse-like discharge in; and a second layer obtained by forming a film consisting mainly of any one of chrome, nickel, iron, tungsten, and molybdenum on the first layer.

### EFFECT OF THE INVENTION

The resistance welding electrode or the resistance welding apparatus of the present invention has a very long service life and can be continuously operated for a long period of time, thereby enabling the system to greatly reduce labor and cost.

In addition, because the part manufacturing line in which the resistance welding apparatus is built allows consumables to be replaced more quickly, productivity of part manufacturing can be improved.

### BRIEF DESCRIPTION OF THE DRAWINGS

FIG. 1 is a schematic for illustrating an overview of a welding apparatus according to a first embodiment of the present invention; and

FIG. 2 is a photograph a cross section of a steel material when a TiC film is formed on the steel material.

### BEST MODE(S) FOR CARRYING OUT THE INVENTION

### FIRST EMBODIMENT

Exemplary embodiments of the present invention will be explained in detail below with reference to the accompanying drawings.

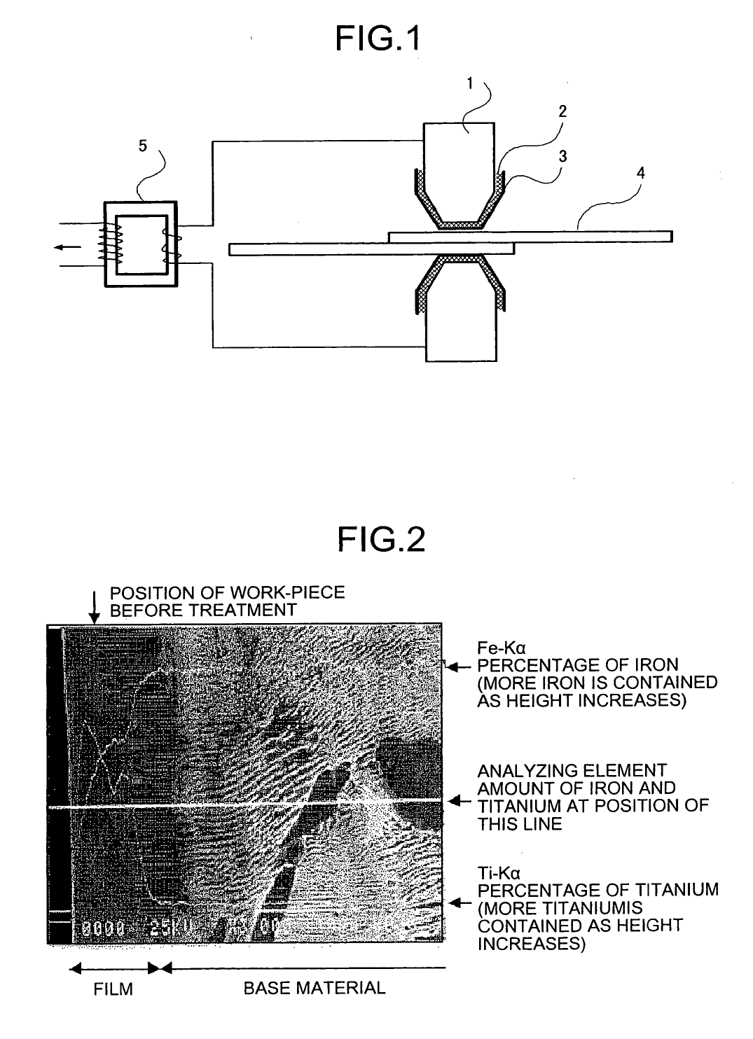

FIG. 1 is a schematic for illustrating a resistance welding electrode and a periphery of the resistance welding electrode according to an embodiment of the present embodiment. A film 2 of metal carbide, for example, titanium carbide (TiC), is formed on a spot welding chip 1 according to the present embodiment, and a nickel-chrome film 3 is formed on the film 2 by plating.

The film 2 of metal carbide is formed by applying voltage between the spot welding chip 1 and a surface treating electrode obtained by heat-treating a powder molding in which a powder including a metal powder that is likely to be carbonized or a metal compound powder as a main component is compression molded, to generate a pulse-like discharge in a working fluid.

In addition, 4 is a metal plate to be bonded by spot welding, 5 is a transformer, and an electrical circuit disposed after the transformer is a well-known one and so is not illustrated.

For the surface treating electrode for forming the film of metal carbide, a TiC film is formed by using an electrode of a titanium series material that is carbonized to form TiC accompanied by discharge of TiC, Ti, or the like in the working fluid.

In addition, for molding the electrode, a slip, a metal injection molding (MIM), a metallization, a method in which nano powder is molded by entrainment in a jet flow, and the like are provided besides the compression molding.

The resistance welding electrode according to the present embodiment includes the film 2 of TiC which is a hard ceramic formed on the surface and a nickel-chrome plated layer 3 further formed thereon as described above.

The hard ceramic may be, for example, titanium nitride, TiCN, silicon carbide (SiC), boron carbide (B₄C) , chrome carbide (Cr₃C₂, and the like), vanadium carbide (VC), zirconium carbide, niobium carbide, molybdenum carbide, tungsten carbide (WC), and the like, which are other materials. However, the results of TiC were excellent in the experiment conducted.

In addition, the film on the hard ceramic also has a similar effect if it is, for example, a film of metal material including chrome (Cr), nickel (Ni), iron (Fe), tungsten (W), molybdenum (Mo), and the like as a main component, which are other materials. Moreover, the films on the hard ceramic are typically relatively high-melting-point materials each having a melting point of one thousand several hundred degrees Celsius.

The metal film is molded on the topmost surface (the nickel-chrome layer according to the present embodiment) by methods such as plating, PVD, CVD, or a method in which a voltage is applied to the region between the molded powder that contains the metal as a main component and the resistance welding electrode to generate a pulse-like discharge in the working fluid. No big differences were observed although the treating methods differed. However, for the hard ceramic layer, which is an intermediate layer, the discharge surface treatment method described below had the biggest effect on prolonging the service life.

The discharge surface treatment is the method disclosed in the international publication No. WO99/58744, the international publication No. WO01/05545, and the international publication No. WO01/23640, and the like. In the method, the film of metal carbide in which an electrode material is carbonized is formed on the surface of a workpiece by applying a voltage to a region between the workpiece and a green compact in which a powder of metal that is likely to be carbonized or a powder including the powder of metal carbide as a main component is compression molded, or a green compact in which the green compact is heat-treated, to generate a pulse-like discharge in the working fluid.

It is found that the conditions of pulse width te is about 4 microseconds to 30 microseconds, peak current value ie is about 5 amperes to 30 amperes are better, and more preferably, pulse width te is about 10 microseconds to 20 microseconds, peak current value ie is about 15 amperes to 20 amperes are better for forming the film.

The hard carbide film formed by the discharge surface treatment features excellent adhesion and the film does not easily peel off.

It is considered that this is because the film surface contains much hard carbide and the material is such that the percentage of the base material tends to increase as it advances inside the material.

FIG. 2 is a photograph of a cross section of a steel material when the TiC film is formed on the steel material. It is found that the region closer to the surface contains much TiC and the base material gradually increases inside the material.

The resistance welding electrode according to the present embodiment is further nickel-chrome plated after forming the TiC film, by performing the discharge surface treatment described above on the electrode. The results of tests to evaluate the service life of resistance welding electrodes made of copper are explained below.

The comparison was performed on the following four kinds of electrodes:

The evaluation results and each service life (comparison with 1) as a conventional electrode) are shown in Table 1

TABLE 1

| | | Service |
|---|---|---|
| | Evaluation results | life |
| 1) No. 1 Copper | The electrode is soft | 1 |
| resistance welding | and wearing is large. | |
| electrode (conventional | | |
| electrode). | | |
| 2) No. 2 Electrode in | Even though the | 1.5 |
| which the surface of the | surface is solidified, | |
| copper resistance welding | it is almost the same | |
| electrode is nickel- | as in No. 1 electrode. | |
| chrome plated. | | |
| 3) No. 3 Electrode in | The surface is | 2 |
| which the TiC film is | solidified and the | |
| formed by performing | service life is | |
| discharge surface | prolonged. | |
| treatment on the copper | | |
| resistance welding | | |
| electrode. | | |
| 4) No. 4 Electrode in | Even though the | 5 |
| which the copper | hardness of the | |
| resistance welding | surface is lower than | |
| electrode is nickel- | that of the No. 3 | |
| chrome plated by | electrode, the amount | |
| performing discharge | of wearing is small as | |
| surface treatment after | good thermal diffusion | |
| forming the TiC film on | might have occurred. | |
| the electrode. | | |

As shown in FIG. 1, even in the No. 2 electrode in which the surface of the copper resistance welding electrode was nickel-chrome plated, and in the No. 3 electrode in which the TiC film was formed by performing discharge surface treatment on the copper resistance welding electrode, the service life of the electrodes was prolonged somewhat. However, in the No. 4 electrode in which the copper resistance welding electrode was nickel-chrome plated by performing discharge surface treatment after forming the TiC film on the electrode, service life was prolonged more than in the case of the No. 2 and No. 3 electrodes.

The reason why the service life of the No. 4 electrode in which the copper resistance welding electrode was nickel-chrome plated by performing discharge surface treatment after forming the TiC film on the electrode, was extremely prolonged is considered to be as follows. It is considered that even though copper is a good thermally conductive material, the melting point is high. On the contrary, TiC is not thermally conductive, but the melting point is high. If the thermal conductivity is poor, the temperature is likely to rise locally, spatter will attach to the electrode and thereby cause the film of the electrode to be easily broken. The TiC film on which discharge surface treatment is performed has such a tendency, and the hard TiC film is an ideal film that is immediately amalgamated with copper which has good thermal conductivity. Melting is prevented by the TiC having a high melting point on the surface, and so heat can be immediately diffused by the copper component underneath.

Thus, it is considered that the service life of the copper resistance welding electrode coated by the TiC. film is about twice as long as that of conventional copper resistance welding electrodes, however, the surface roughness of the film on which discharge surface treatment is performed is rough at about 10 micrometers, and the thickness of the film is very uneven, which limits the prolongation of service life. To overcome this disadvantage, the surface is covered with a material of relatively high melting point. This is the basis of the present invention.

Resistance welding such as spot welding is often used by being built into a part processing manufacturing line. For example, it is well known that a number of resistance welding devices are used for assembling car bodies, and the like.

The automation of these manufacturing lines through the use of robots, and the like has advanced. However, automation has hardly advanced in the field of replacing the resistance welding electrodes, which are consumed in proportion with the number of times of welding.

An important point in operating a part manufacturing line is how to shorten line stoppages required for replacing consumables, and the like on the line.

In this regard, the replacement of resistance welding electrode is a problem because the line needs to be stopped every few days to replace the electrodes. However, by using the resistance welding electrode described according to the present embodiment, the service life of the electrode itself can be greatly prolonged, and the frequency of replacing resistance welding consumables is lessened, thereby enabling the system to shorten line stoppages and largely increase productivity.

The resistance welding electrode or resistance welding apparatus of the present invention has a very long service life and can be continuously used for a long period of time, thereby enabling the system to greatly reduce labor and cost.

In addition, the productivity of part manufacture on a part manufacturing line can be improved because line stoppages for replacing consumables of the part manufacturing line in which the resistance welding apparatus is built can be shortened.

### INDUSTRIAL APPLICABILITY

The resistance welding electrode of the present invention is suitable for a resistance welding apparatus used in a part manufacturing line.

1-7. (canceled)

8. A resistance welding electrode comprising:
a first layer of a metal-carbide film that is formed by attaching or carbonizing of an electrode material on a surface of the resistance welding electrode by applying a voltage between a powder molding obtained by molding a powder consisting mainly of a metal powder that is likely to be carbonized or a metal compound powder or a powder molding obtained by heating the powder molding in a working fluid and the resistance welding electrode, to generate a pulse-like discharge in; and
a second layer obtained by forming a film consisting mainly of any one of chrome, nickel, iron, tungsten, and molybdenum on the first layer.

9. The resistance welding electrode according to claim 8, wherein the resistance welding electrode consists mainly of either one of copper and iron.

10. The resistance welding electrode according to claim 8, wherein
the second layer is formed on the first layer by any one of plating, physical vapor deposition, chemical vapor deposition, and a method of generating the pulse-like discharge by applying the voltage between a powder molding obtained by molding a metal-based powder and the resistance welding electrode in the working fluid.

11. A method of manufacturing a resistance welding electrode, the method comprising:
forming a first film of metal carbide that is formed by attaching or carbonizing of an electrode material on a surface of the resistance welding electrode, the forming including disposing the resistance welding electrode in a working fluid;
disposing a powder molding obtained by molding a powder consisting mainly of a metal powder that is likely to be carbonized or a metal compound powder or a powder molding obtained by heating the powder molding in an opposite position to the resistance welding electrode, as an electrode for discharge surface treatment; and
applying a predetermined voltage between the resistance welding electrode and the powder molding, to generate a pulse-like discharge; and
forming a second film consisting mainly of any one of chrome, nickel, iron, tungsten, and molybdenum on the first film.

12. The method according to claim 11, wherein
the second film is formed on the first film by any one of plating, physical vapor deposition, chemical vapor deposition, and a discharge surface treatment method of generating the pulse-like discharge by applying the voltage between a powder molding obtained by molding a metal-based powder and the resistance welding electrode in the working fluid.

13. A resistance welding apparatus comprising:
a resistance welding electrode including
a first layer of a metal-carbide film that is formed by attaching or carbonizing of an electrode material on a surface of the resistance welding electrode by applying a voltage between a powder molding obtained by molding a powder consisting mainly of a metal powder that is likely to be carbonized or a metal compound powder or a powder molding obtained by heating the powder molding in a working fluid and the resistance welding electrode, to generate a pulse-like discharge in; and
a second layer obtained by forming a film consisting mainly of any one of chrome, nickel, iron, tungsten, and molybdenum on the first layer; and
a power supplying unit that supplies an electric power to the resistance welding electrode.

14. A part manufacturing line for performing a part welding, wherein
the part welding is performed by using a resistance welding apparatus, and
the resistance welding apparatus includes
a resistance welding electrode including
a first layer of a metal-carbide film that is formed by attaching or carbonizing of an electrode material on a surface of the resistance welding electrode by applying a voltage between a powder molding obtained by molding a powder consisting mainly of a metal powder that is likely to be carbonized or a metal compound powder or a powder molding obtained by heating the powder molding in a working fluid and the resistance welding electrode, to generate a pulse-like discharge in; and
a second layer obtained by forming a film consisting mainly of any one of chrome, nickel, iron, tungsten, and molybdenum on the first layer; and
a power supplying unit that supplies an electric power to the resistance welding electrode.

15. A machine part that is used under a high-temperature condition, the machine part comprising:
a first layer of a metal-carbide film that is formed by attaching or carbonizing of an electrode material on a surface of a resistance welding electrode by applying a voltage between a powder molding obtained by molding a powder consisting mainly of a metal powder that is likely to be carbonized or a metal compound powder or a powder molding obtained by heating the powder molding in a working fluid and the resistance welding electrode, to generate a pulse-like discharge in; and
a second layer obtained by forming a film consisting mainly of any one of chrome, nickel, iron, tungsten, and molybdenum on the first layer.

16. The machine part according to claim 15, wherein
the resistance welding electrode consists mainly of either one of copper and iron.

17. The machine part according to claim 15, wherein
the second layer is formed on the first layer by any one of plating, physical vapor deposition, chemical vapor deposition, and a method of generating the pulse-like discharge by applying the voltage between a powder molding obtained by molding a metal-based powder and the resistance welding electrode in the working fluid.

18. A method of manufacturing a machine part that is used under a high-temperature condition, the method comprising:
forming a first film of metal carbide that is formed by attaching or carbonizing of an electrode material on a surface of a resistance welding electrode, the forming including
disposing the resistance welding electrode in a working fluid;
disposing a powder molding obtained by molding a powder consisting mainly of a metal powder that is likely to be carbonized or a metal compound powder or a powder molding obtained by heating the powder molding in an opposite position to the resistance welding electrode, as an electrode for discharge surface treatment; and
applying a predetermined voltage between the resistance welding electrode and the powder molding, to generate a pulse-like discharge; and
forming a second film consisting mainly of any one of chrome, nickel, iron, tungsten, and molybdenum on the first film.

19. The method according to claim 18, wherein
the second film is formed on the first film by any one of plating, physical vapor deposition, chemical vapor deposition, and a discharge surface treatment method of generating the pulse-like discharge by applying the voltage between a powder molding obtained by molding a metal-based powder and the resistance welding electrode in the working fluid.
